(19) United States
(12) Patent Application Publication
(10) Pub. No.: US 2008/0036289 A1
(43) Pub. Date: Feb. 14, 2008

(54) VEHICLE BRAKING SYSTEMS

(76) Inventors: Richard Edgar Thompson, Monmouthshire (GB); John Murdoch Robertson, Cheshire (GB); Albert Juanpere, Barcelona (ES); Richard Martin Bellingham, Wrexham (GB); Michael James Gaywood, Newport (GB); Martin Pors Taylor, Torfaen (GB); Sridhar Aprameya, West Midlands (GB); Shan Shih, Troy, MI (US); Jonathan Leslie Christopher Jackson, Herefordshire (GB)

Correspondence Address: CARLSON, GASKEY & OLDS, P.C., 400 WEST MAPLE ROAD, SUITE 350, BIRMINGHAM, MI, 48009, US

(21) Appl. No.: 11/743,820

(22) Filed: May 3, 2007

(30) Foreign Application Priority Data
May 3, 2006 (GB) GB 0608740.7

(51) Int. Cl. B60B 35/00

(52) U.S. Cl. 301/125

(57) ABSTRACT

A tubular vehicle axle includes a primary air brake actuator within the axle. A tubular wall of the axle defines a pressure vessel of the primary actuator. The primary actuator has an output axis coincident with a rotary axis of the axle. An auxiliary air actuator can be directly operable on the primary actuator.

### REFERENCE TO RELATED APPLICATIONS

This application claims priority to Great Britain Patent Application GB 0608740.7 filed on May 3, 2006.

### BACKGROUND OF THE INVENTION

This invention relates generally to vehicle braking systems, and in particular with actuators for wheel brakes of commercial vehicles.

Passenger and light commercial vehicles generally use hydraulic fluid as an actuation medium in a closed system. Heavy commercial vehicles rely upon air under pressure as the actuating medium; such systems are open in that air is exhausted to atmosphere from a vicinity of wheel brakes.

One difficulty with air systems is that the necessary air actuator has a relatively large diameter and axial length in order to achieve the necessary actuation force, while keeping piston travel and lever ratio within acceptable limits. Such an actuator is typically mounted on a backplate of a drum brake, or directly onto a caliper of a disc brake, and protrudes into a wheel arch space. However, the space available is severely constrained by the vehicle chassis, the suspension, the axle, the hub and the wheel design.

What is required is an improved actuator which has a reduced space requirement, but remains compatible with existing actuation systems and wheel brake components.

### SUMMARY OF THE INVENTION

According to a first aspect of the invention, there is provided a primary air brake actuator of a vehicle. A housing of the primary air brake actuator includes an axle of the vehicle. A tubular wall of the axle defines a pressure vessel of the primary air brake actuator. According to a second aspect of the invention, a tubular axle of a vehicle defines a primary air brake actuator within the tubular axle, and a tubular wall of the tubular axle defines a pressure vessel of the primary air brake actuator.

A moving component of the primary air brake actuator may be a diaphragm anchored relative to an inner surface of an axle wall. The moving component may be a piston slidable directly on the inner surface of the axle wall. The primary air brake actuator may alternatively be a self-contained unit including a drum-like housing and adapted for insertion and retention within the axle housing.

In one embodiment, the primary air brake actuator has an output rod co-axial with an axis of rotation of the axle and a corresponding lever protruding through a casing to operate a brake of the axle. In one embodiment, the lever is generally radial of the axis of rotation and is pivoted immediately adjacent a radially outer end. The lever passes through a narrow slot in a wall of the axle, and the slot extends parallel to the axis.

In one embodiment, the axle further defines an auxiliary air brake actuator in series with the primary air brake actuator, and in one example axially inboard of the primary air brake actuator. The auxiliary air brake actuator is the springboard kind in which air under pressure holds the auxiliary air brake actuator in an off condition. The moving component of the auxiliary air brake actuator may be a diaphragm or piston of the type mentioned above. The primary and auxiliary air brake actuators can be co-axial and on a rotary axis of the axle.

In one embodiment, a helical spring is provided inboard of the auxiliary air brake actuator and is operable to urge the moving component axially outward. The helical spring is anchored directly on an interior of the axle housing, in one example.

According to a further aspect of the present invention, there is provided a tubular vehicle axle having a primary air brake actuator in the tubular vehicle axle. The primary air brake actuator has an output axis coincident with a rotary axis of an axle.

According to a still further aspect of the present invention, there is provided a tubular vehicle axle having a primary air brake actuator in the tubular vehicle axle and an auxiliary air actuator in the tubular vehicle axle and directly operable on the primary air brake actuator.

### BRIEF DESCRIPTION OF THE DRAWINGS

Other features of the invention will be apparent from the following description of an embodiment with reference to the accompanying drawings in which:

FIG. 1 is a schematic representation of a prior art brake arrangement;

FIG. 2 is a schematic representation of a brake arrangement according to the present invention; and

FIG. 3 is a more detailed schematic representation of the kind of arrangement illustrated in FIG. 2.

### DETAILED DESCRIPTION OF THE PREFERRED EMBODIMENT

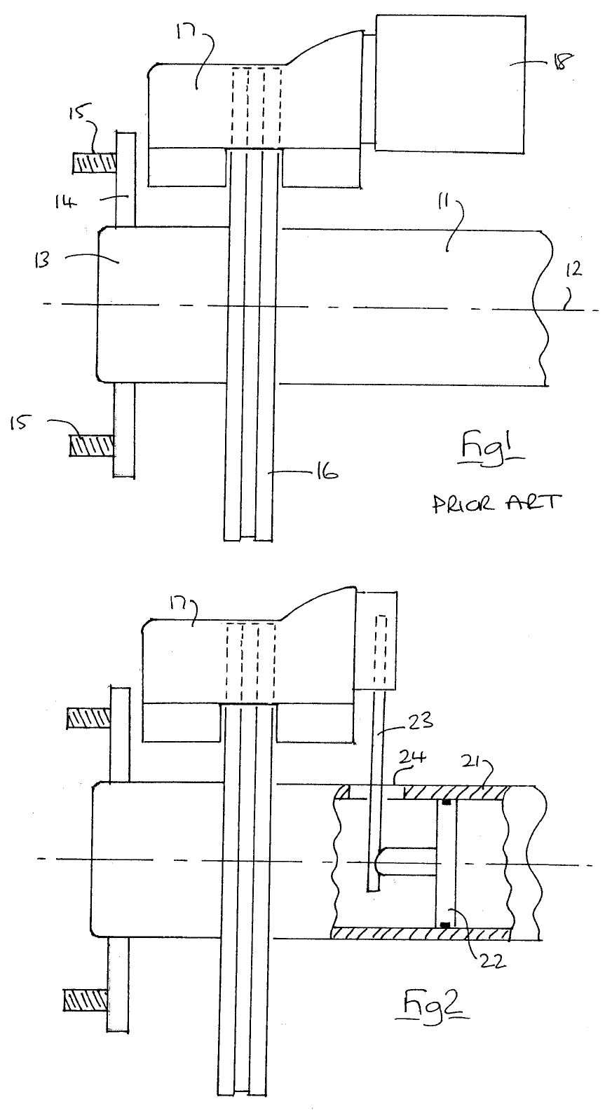

With reference to the drawings, FIG. 1 illustrates a conventional arrangement in which a vehicle axle 11 has a centerline axis 12. Rotatable about the centerline axis 12 is a hub 13 having a flange 14 for vehicle wheel studs 15 and a brake rotor 16. A brake caliper 17 extends on either side of the brake rotor 16 and has an actuator 18 whereby opposite brake pads (not shown) can be urged against opposite annular faces of the brake rotor 16. The actuator 18 generally includes a cylindrical container within which a piston or diaphragm can be urged axially by the admission of air under pressure to one side. Typically, the actuator 18 acts via a lever onto a pad centerline, and a suitable wear adjuster and return spring is incorporated. The brake caliper 17 may be fixed, but is more typically floating. Brake torque is reacted by suitable mountings of the vehicle axle 11.

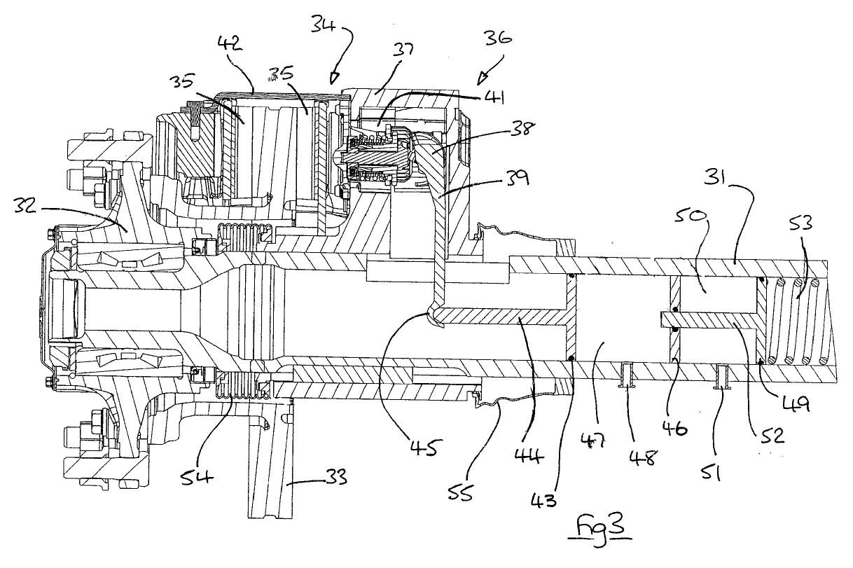

In the inventive arrangement according to FIG. 2, the actuator 18 is housed within a tubular axle 21, which in this embodiment acts directly acts as a cylinder for a piston 22. A lever 23 passes through a slot 24 in the tubular axle 21 to actuate brake pads. Suitable return spring and dust bats are provided. A much smaller housing 25 is provided on a body of the brake caliper 17, thus making valuable space available in a wheel arch area inboard of the brake caliper 17. Because the space within the tubular axle 21 is not used for any other purpose, there are no consequent space constraints for other components. Furthermore, an entire axial length of the tubular axle 21 is available for use, which means that travel restrictions of conventional actuators need not apply.

A detailed schematic arrangement is illustrated in FIG. 3, in which an undriven tubular axle 31 has a reduced diameter end portion on which a rotatable hub 32 is mounted via suitable roller bearings. A brake rotor 33 is bolted to and rotatable with the rotatable hub 32, and the brake rotor 33 extends inboard of the rotatable hub 32. Located over the brake rotor 33 is a floating brake caliper 34 having opposite brake pads 35. The floating brake caliper 34 is anchored on the tubular axle 31 in any suitable manner to resist braking torque.

An actuation assembly 36 includes a housing 37 and one end 38 of a lever 39 pivoted in the housing 37. The lever 39 acts directly on an inboard brake pad via an adjuster mechanism 41 and indirectly on an outboard brake pad via a usual caliper yoke 42 (such an arrangement is conventional).

Within the tubular axle 31 is provided a primary piston 43 having a strut 44 acting as the other end 45 of the lever 39. Inboard of the primary piston 43, a partition wall 46 defines a closed chamber 47 having an inlet/outlet port 48 in the wall of the tubular axle 31.

An auxiliary piston 49 defines a closed chamber 50 on the other side of the partition wall 46. An inlet/outlet port 51 is in the wall of the tubular axle 31. The auxiliary piston 49 has a strut 52 which extends in a sealed manner through the partition wall 46, as illustrated in FIG. 3. A heavy coil spring 53 urges the auxiliary piston 49 in an outboard direction and reacts against an internal abutment of the tubular axle 31, which is not shown. Suitable boots 54 and 55 seal the interior of the tubular axle 31 against moisture and dirt.

In use, admission of air under pressure via the inlet/outlet port 48 causes the primary piston 43 to move to the right as viewed in FIG. 3, thus causing the lever 39 to pivot clockwise and apply the brake pads to the brake rotor 33 via the adjuster 41. When the inlet/outlet port 48 is connected to exhaust, the primary piston 43 returns. An additional release spring may be provided if necessary.

The auxiliary piston 49 provides a park brake/emergency brake. In normal operation, air under pressure is admitted via the inlet/outlet port 51 so that the auxiliary piston 49 is urged to the right as viewed in FIG. 3, compressing still further the heavy coil spring 53. If air is exhausted from the closed chamber 50, the auxiliary piston 49 moves to the left under the action of the heavy coil spring 53, and the strut 52 directly acts on the primary piston 43 to apply the brake pads to the brake rotor 33.

One end of an axle is illustrated. Corresponding mirror image components will be provided for the wheel brake at the other end of the axle.

Instead of a piston acting directly on the interior of the axle casing, a tubular sleeve may be provided. The actuator may have diaphragms in place of the pistons. Furthermore, the actuator may includes one or more self contained units inserted into the axle upon assembly of the actuator.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

1. A tubular vehicle axle comprising:
a primary air brake actuator in the tubular vehicle axle, wherein a tubular wall of the tubular vehicle axle defines a pressure vessel of the primary air brake actuator.

2. The tubular vehicle axle according to claim 1 wherein the tubular wall defines a cylinder for a piston of the primary air brake actuator.

3. The tubular vehicle axle according to claim 1 wherein the primary air brake actuator has an output axis coincident with a rotary axis of the tubular vehicle axle.

4. The tubular vehicle axle according to claim 3 wherein the primary air brake actuator has an output strut movable along the rotary axis.

5. The tubular vehicle axle according to claim 4 wherein the primary air brake actuator further includes a lever pivotably connected to the output strut and passing through the tubular wall of the tubular vehicle axle in a plane coincident with the output axis.

6. The tubular vehicle axle according to claim 1 further including an auxiliary air actuator in the tubular vehicle axle and directly operable on the primary air brake actuator.

7. The tubular vehicle axle according to claim 6 wherein the primary air brake actuator and the auxiliary air actuator are in series.

8. The tubular vehicle axle according to claim 7 wherein the auxiliary air actuator is axially inboard of the primary air brake actuator.

9. The tubular vehicle axle according to claim 6 further including a helical compressor spring axially inboard of the auxiliary air actuator and directly operable on the auxiliary air actuator.

10. A tubular vehicle axle comprising:
a primary air brake actuator in the tubular vehicle axle, wherein the primary air brake actuator includes an output axis coincident with a rotary axis of the tubular vehicle axle.

11. A tubular vehicle axle comprising:
a primary air brake actuator in the tubular vehicle axle; and
an auxiliary air actuator in the tubular vehicle axle and directly operable on the primary air brake actuator.

12. The tubular vehicle axle according to claim 8 wherein the primary air brake actuator is located between the auxiliary air actuator and a rotary hub.

13. The tubular vehicle axle according to claim 9 wherein the helical compressor spring is on a side of the auxiliary air spring distal from the primary air brake actuator.
